(19) United States
(12) Patent Application Publication
(10) Pub. No.: US 2025/0091345 A1
(43) Pub. Date: Mar. 20, 2025

(54) LIQUID EJECTION HEAD, AND MANUFACTURING METHOD FOR LIQUID EJECTION HEAD

(71) Applicant: CANON KABUSHIKI KAISHA, Tokyo (JP)

(72) Inventors: YURIKA KUROGI, Kanagawa (JP); SHUZO IWANAGA, Kanagawa (JP); KOICHI ISHIDA, Tokyo (JP); FUMI TANAKA, Kanagawa (JP); TAKATSUGU MORIYA, Tokyo (JP); YOSHIHIRO HAMADA, Kanagawa (JP); SAORI NARUKAWA, Kanagawa (JP); KEIJI TOMIZAWA, Kanagawa (JP); KAZUHIRO ASAI, Kanagawa (JP); TOSHIAKI KANEKO, Tokyo (JP)

(21) Appl. No.: 18/883,547

(22) Filed: Sep. 12, 2024

(30) Foreign Application Priority Data
Sep. 14, 2023 (JP) 2023-149010

(51) Int. Cl. B41J 2/14; B41J 2/16

(52) U.S. Cl. CPC B41J 2/14072; B41J 2/14024; B41J 2/1404; B41J 2/14201; B41J 2/1601; B41J 2/1607; B41J 2/1631; B41J 2/164; B41J 2002/14491

(57) ABSTRACT

A liquid ejection head includes an element substrate, an electric wiring board, and a sealant. The element substrate includes a substrate having a first face, and an element, a channel forming member, and a pad array that are disposed at the first face of the substrate. The element is configured to eject a liquid. The channel forming member includes a pressure chamber, and an ejection port communicating with the pressure chamber and through which the liquid is ejected. The pad array includes multiple pads electrically connected to the element and arranged along one side of the substrate. The electric wiring board is connected to each pad via an electric connection part. The sealant is disposed on the first face of the substrate, and surrounds the electric connection part. In the element substrate, the channel forming member has an opening, and the pad array is located within the opening.

### BACKGROUND

### Field

The present disclosure relates to a liquid ejection head, and a manufacturing method for the liquid ejection head.

### Description of the Related Art

Liquid ejection heads equipped to liquid ejection apparatuses such as inkjet printers include an element substrate, and a nozzle plate. The element substrate includes an element that pressurizes a liquid. The nozzle plate includes an ejection port. As the element is driven, a liquid is pressurized. The pressurized liquid is ejected out of the head as a droplet through the ejection port. The element substrate including the element is provided with an electrode (e.g., an electrode pad) that is electrically connected to an electrical wiring board to receive, from an external source, electric power for driving the element. An electric connection part that connects the electrode and the electrical wiring board, such as a wire or an inner lead, is sealed with a sealant such as a resin material to reduce adhesion of ink. The sealant is applied to the electric connection part, and the applied sealant is allowed to cure by heating or other methods to thereby cover the electric connection part.

If, however, the sealant flows from a location on the element substrate where the sealant has been applied, this may in some cases result in the inability to provide adequate coverage of the electric connection part. Accordingly, some liquid ejection heads include, on the element substrate, a member that serves as a wall to prevent such flowing of the sealant. For example, Japanese Patent Laid-Open No. 2014-000733 discloses a liquid ejection head with an insulating member disposed between an electrode pad array on the element substate, and an edge of the substrate corresponding to the electrode pad array. The insulating member disclosed in Japanese Patent Laid-Open No. 2014-000733 is formed by photolithography simultaneously with an adhesion layer from the same material as that of the adhesion layer. The adhesion layer is provided between the element substrate and the nozzle plate to improve adhesion between the element substrate and the nozzle plate.

With the liquid ejection head disclosed in Japanese Patent Laid-Open No. 2014-000733, the wall for preventing the sealant from flowing to the outside of the element substrate is formed by using the adhesion layer. The adhesion layer, however, generally has a small height, which means that an increase in the amount of the sealant applied may potentially cause the sealant to overflow beyond the wall to the outside of the element substrate. Such flowing of the sealant may cause bubbles to become entrapped within the sealant. The bubbles may expand during thermal curing of the sealant, which may potentially lead to exposure of the electric connection part.

### SUMMARY

The present disclosure provides a liquid ejection head in which, on an element substrate, a wall for reducing flowing of a sealant is formed by using a channel forming member used to define a channel. The liquid ejection head therefore makes it easier to prevent the sealant from flowing from its applied location, and provides improved electric reliability.

The present disclosure provides a liquid ejection head including an element substrate, an electric wiring board, and a sealant. The element substrate includes a substrate, an element, a channel forming member, and a pad array. The substrate has a first face. The element is configured to eject a liquid. The channel forming member includes a pressure chamber and an ejection port. The ejection port is a port communicating with the pressure chamber and through which the liquid is ejected. The pad array includes a plurality of pads electrically connected to the element and arranged along one side of the substrate. The element, the channel forming member, and the pad array are disposed at the first face of the substrate. The electric wiring board is connected to each of the plurality of pads via an electric connection part. The sealant is disposed on the first face of the substrate, and surrounds the electric connection part. In plan view of the element substrate, the channel forming member has an opening, and the pad array is located within the opening.

Further features of the present disclosure will become apparent from the following description of exemplary embodiments with reference to the attached drawings.

### BRIEF DESCRIPTION OF THE DRAWINGS

FIG. 1 illustrates a liquid ejection apparatus according to some embodiments of the present disclosure.

FIG. 2 conceptually illustrates a control system according to some embodiments.

FIG. 3 schematically illustrates a liquid circulation path according to some embodiments.

FIGS. 4A and 4B are perspective views of a liquid ejection head according to some embodiments.

FIG. 5 is an exploded perspective view of the liquid ejection head according to some embodiments.

FIGS. 6A to 6D are plan views of a channel member according to some embodiments.

FIGS. 7A and 7B are a see-through view and a cross-sectional view, respectively, of the channel member and an ejection module according to some embodiments.

FIGS. 8A and 8B are a perspective view and an exploded perspective view, respectively, of the ejection module according to some embodiments.

FIGS. 9A to 9C are plan views of an element substrate according to some embodiments.

FIG. 10 is a perspective cross-sectional view of the element substrate according to some embodiments.

FIGS. 11A and 11B are a plan view and a cross-sectional view, respectively, of the interior of the liquid ejection head according to some embodiments.

FIGS. 12A and 12B are enlarged plan views of the vicinity of an ejection port of the liquid ejection head according to some embodiments.

FIG. 13 is a partial enlarged plan view of a part where element substrates are adjacent to each other according to some embodiments.

FIG. 14A is a plan view of the element substrate according to the related art.

FIG. 14B is a cross-sectional view of the ejection module according to the related art.

FIGS. 15A and 15B are plan views of the element substrate according to a first embodiment.

FIG. 15C is a cross-sectional view of the ejection module according to the first embodiment.

FIGS. 16A and 16B are plan views of the element substrate according to a second embodiment.

FIGS. 17A and 17B are plan views of the element substrate according to a third embodiment.

FIG. 17C is a cross-sectional view of the ejection module according to the third embodiment.

FIGS. 18A and 18B are plan views of the element substrate according to a fourth embodiment.

### DESCRIPTION OF THE EMBODIMENTS

Various exemplary embodiments, features, and aspects of the present disclosure are described below with reference to the drawings. It is to be noted, however, that the description below is not intended to limit the scope of the present disclosure. In one example, the embodiments employ the thermal method, which uses a heating element to generate an air bubble to thereby eject a liquid. However, the embodiments are also applicable to liquid ejection heads employing the piezoelectric method, which uses a piezoelectric element as an energy-generating element for ejecting a liquid, and various other liquid ejection methods. The liquid ejection head according to the present disclosure, and a liquid ejection apparatus according to the present disclosure that incorporates the liquid ejection head are applicable to apparatuses such as inkjet printers, copying machines, facsimiles including a communication system, and word processors including a printer unit. Further, the present disclosure is applicable to industrial recording apparatuses combined in a complex manner with various processors. Other exemplary applications of the present disclosure may include biochip fabrication, printing of electronic circuits, and semiconductor substrate fabrication.

Although the embodiments are directed to a liquid ejection apparatus of a type in which a liquid such as ink is circulated between a tank and the liquid ejection head, the embodiments may be directed to other types of liquid ejection apparatuses. For example, the liquid ejection apparatus may be of a type in which a liquid is not circulated but instead two tanks are provided, one upstream of the liquid ejection head and one downstream of the liquid ejection head, and a liquid is passed from one of two tanks to the other tank to allow the liquid within a pressure chamber to flow. Although the embodiments are directed to a so-called line-type (page-wide) head, which has a length corresponding to the width of a recording medium, the embodiments are also applicable to a so-called serial-type liquid ejection head, with which recording is performed as the liquid ejection head is scanned across the recording medium. Exemplary configurations of the serial-type liquid ejection head include, but are not limited to, a configuration incorporating one element substrate for black ink and one element substrate for chromatic color ink. In an alternative configuration, a short line head shorter than the width of a recording medium may be prepared, and the short line head may be scanned across the recording medium. The short line head includes several element substrates arranged in the direction of an ejection port array in such a way that ejection ports overlap the element substrates.

### First Embodiment

### General Arrangement of Apparatus

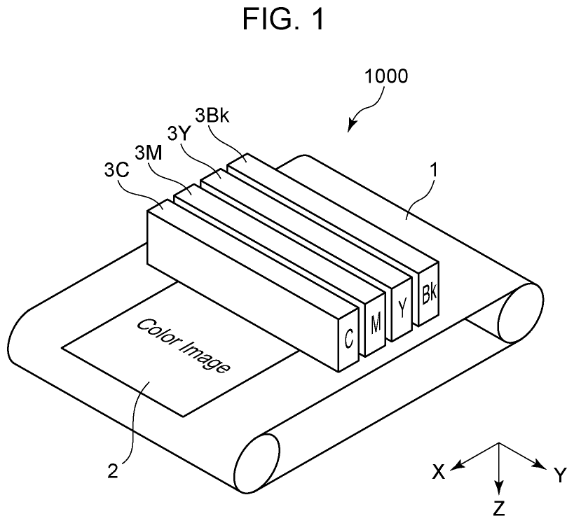

FIG. 1 illustrates an example of a liquid ejection apparatus according to a first embodiment. The liquid ejection apparatus according to the first embodiment is a liquid ejection apparatus 1000 (to be also referred to simply as “apparatus 1000” hereinafter), which serves as an inkjet printer that records a color image on a recording medium 2 by ejecting the following colors of ink: yellow (Y), magenta (M), cyan (C), and black (Bk). In FIG. 1, the X-direction represents the conveyance direction of the recording medium 2, the Y-direction represents the direction of width of the recording medium, and the Z-direction represents a direction that crosses the X-direction and the Y-direction and in which a liquid is ejected.

FIG. 1 illustrates the apparatus 1000 of a type in which liquid ejection heads 3 directly apply ink onto the recording medium 2 conveyed in the X-direction. The recording medium 2 is mounted on a conveyance part 1, and conveyed at a predetermined speed below four liquid ejection heads 3 (3C, 3M, 3Y, and 3Bk) that each eject a different color of ink. In FIG. 1, the four liquid ejection heads 3 are disposed in the X-direction in the following order: 3Bk, 3Y, 3M, and 3C, and ink is applied onto the recording medium 2 in the following order of colors: black, yellow, magenta, and cyan. In each individual liquid ejection head 3, multiple ejection ports for ejecting ink are arranged in the Y-direction.

Although the recording medium 2 is depicted in FIG. 1 as being cut paper, the recording medium 2 may be continuous paper fed from a roll of paper. The recording medium is not limited to paper but may be, for example, a film.

Although the first embodiment is directed to a liquid ejection apparatus in which each one liquid ejection head is configured to eject a single color of ink, each one liquid ejection head may be configured to eject multiple colors of ink. Alternatively, the liquid ejection head may be configured to eject a liquid other than ink, such as a reaction liquid or an overcoat agent.

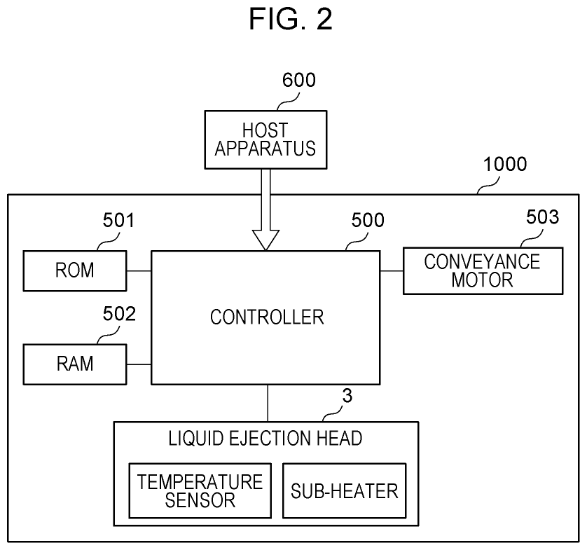

FIG. 2 is a block diagram for explaining the configuration of control performed by the liquid ejection apparatus 1000. A controller 500 is, for example, a CPU. The controller 500 controls, while using a RAM 502 as a work area, the overall operation of the liquid ejection apparatus 1000 in accordance with a program or various parameters stored in a ROM 501. The controller 500 performs, in accordance with the program and the parameters stored in the ROM 501, predetermined image processing on image data received from an externally connected host apparatus 600, and generates ejection data that allows the liquid ejection head 3 to perform ejection. The controller 500 drives the liquid ejection head 3 in accordance with the ejection data, and causes ink to be ejected at a predetermined frequency.

During an ejection operation performed with the liquid ejection head 3, the controller 500 drives a conveyance motor 503 to convey the recording medium 2 in the X-direction at a speed corresponding to the drive frequency. An image according to the image data received from the host apparatus 600 is thus recorded onto the recording medium 2. The ROM 501 stores, in a rewritable manner for each individual liquid ejection head 3, information about a usage area regarding which ejection ports are to be used for ejection in the liquid ejection head 3.

### Liquid Circulation Path

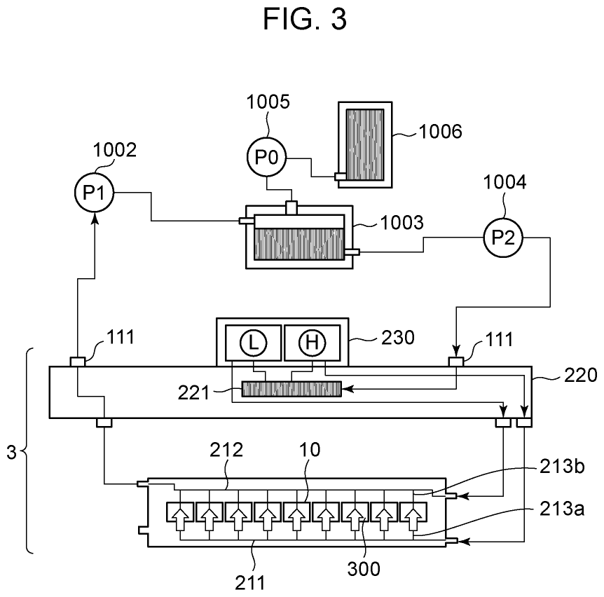

FIG. 3 schematically illustrates a liquid circulation path in the liquid ejection apparatus according to the first embodiment, with the liquid ejection head 3 in fluid connection with components such as a first circulation pump 1002 and a buffer tank 1003. Although FIG. 3 depicts only a path in which ink for a liquid ejection head corresponding to a single color of ink flows, the apparatus 1000 is provided with a circulation path corresponding to each type of the liquid to be ejected, such as ink.

The buffer tank 1003 serves as a sub-tank connected to a main tank 1006. The buffer tank 1003 has an atmosphere communication port (not illustrated) that provides communication between the interior of the tank and the external environment. The buffer tank 1003 thus allows air bubbles in ink to be discharged to the external environment. The buffer tank 1003 is connected also to a replenishing pump 1005. A liquid is consumed in the liquid ejection head 3 as ink is ejected (discharged) from ejection ports in the liquid ejection head, such as during recording or suction recovery performed by ejection of ink. The replenishing pump 1005 transfers ink from the main tank 1006 to the buffer tank 1003 by an amount corresponding to the amount of ink consumed at this time.

The first circulation pump 1002 serves to draw a liquid from a liquid connection part 111 of the liquid ejection head 3, and direct the liquid to the buffer tank 1003. When the liquid ejection head 3 is driven, a fixed amount of ink flows in a common collection channel 212 due to the first circulation pump 1002.

A negative-pressure control unit 230 is disposed in the path between a second circulation pump 1004 and a liquid ejection unit 300. The negative-pressure control unit 230 serves to, even when the flow rate fluctuates in the circulation system due to differences in the duty at which recording is performed, allow the pressure downstream of the negative-pressure control unit 230 (i.e., closer to the liquid ejection unit 300) to be maintained at a preset fixed pressure.

As illustrated in FIG. 3, the negative-pressure control unit 230 includes two pressure-regulating mechanisms. Different control pressures are set for the two pressure-regulating mechanisms. Of the two pressure-regulating mechanisms, the one with a relatively high pressure setting (a negative-pressure controller 230H, which is indicated at “H” in FIG. 3) and the one with a relatively low pressure setting (a negative-pressure controller 230L, which is indicated at “L” in FIG. 3) are respectively connected, via a liquid supply unit 220, to a common supply channel 211 and the common collection channel 212, which are provided in the liquid ejection unit 300. The liquid ejection unit 300 is provided with the common supply channel 211, the common collection channel 212, individual supply channels 213a, and individual collection channels 213b. The individual supply channels 213a and the individual collection channels 213b each communicate with the corresponding element substrate having ejection ports. Details of an element substrate 10 will be given later. The individual channels 213 communicate with the common supply channel 211 and the common collection channel 212. Accordingly, a portion of the liquid delivered by the second circulation pump 1004 passes from the common supply channel 211 to the common collection channel 212 through a channel inside each element substrate 10 (as indicated by the open arrows in FIG. 3). This is because a pressure difference is provided between the pressure-regulating mechanism H connected to the common supply channel 211, and the pressure-regulating mechanism L connected to the common collection channel 212, and the first circulation pump 1002 is connected to only the common collection channel 212.

In this way, the following flows of liquid occur in the liquid ejection unit 300: a flow directed to pass through the interior of the common collection channel 212; and a flow directed to pass through the interior of each element substrate 10 from the common supply channel 211 to the common collection channel 212. As a result, the flow directed from the common supply channel 211 to the common collection channel 212 allows heat generated in each element substrate 10 to be discharged to the outside of the element substrate 10. The configuration mentioned above makes it possible to, during recording performed with the liquid ejection head 3, generate a flow of ink even in a location such as an ejection port or pressure chamber where recording is not being performed. This helps to reduce thickening of ink in such a location. The configuration mentioned above also allows thickened ink or foreign matter in ink to be discharged to the common collection channel 212. The liquid ejection head 3 according to the first embodiment is therefore capable of high-speed and high-quality recording.

### Configuration of Liquid Ejection Head

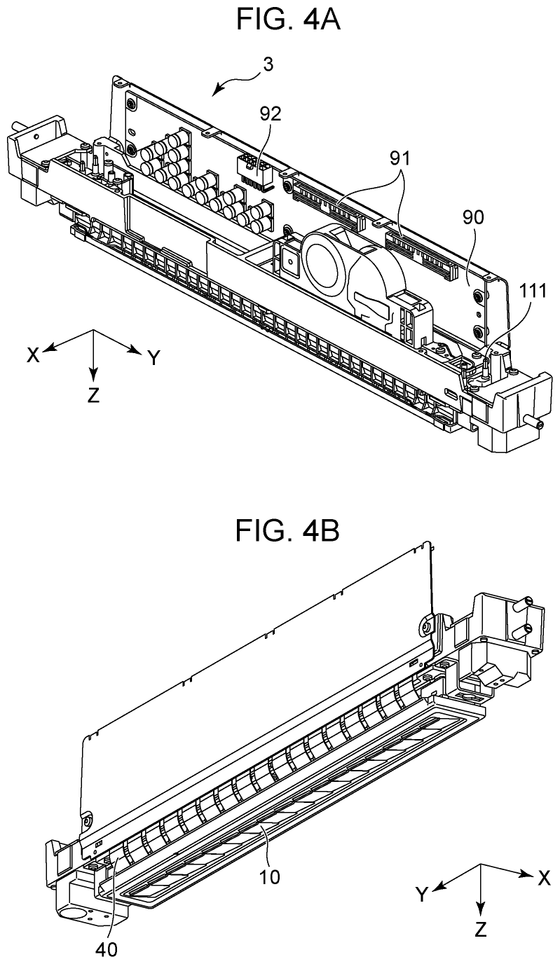

FIGS. 4A and 4B are perspective views of the liquid ejection head 3 according to the first embodiment. The liquid ejection head 3 is a line-type liquid ejection head in which 17 element substrates 10 capable of ejecting ink are arranged in a straight line (disposed in an inline configuration). As illustrated in FIGS. 4A and 4B, the liquid ejection head 3 includes signal input terminals 91 and a power supply terminal 92, which are electrically connected to each element substrate 10 via an electric wiring board (flexible wiring board) 40 and an electric wiring board 90. The signal input terminals 91, and the power supply terminal 92 are electrically connected to the controller of the apparatus 1000. The signal input terminals 91, and the power supply terminal 92 supply an ejection drive signal, and power used for ejection, respectively, to each element substrate 10. Consolidating wiring by using the electric circuitry within the electric wiring board 90 allows the number of signal input terminals 91 and the number of power supply terminals 92 to be reduced relative to the number of element substrates 10. This helps to reduce the number of electric connection parts required in mounting the liquid ejection head 3 to the liquid ejection apparatus 1000, or the number of electric connection parts that need to be removed in replacing the liquid ejection head 3 from the liquid ejection apparatus 1000. As illustrated in FIG. 4A, the liquid connection part 111 disposed at one side of the liquid ejection head 3 is connected to a liquid supply system of the apparatus 1000. Due to this configuration, ink is supplied from the supply system of the apparatus 1000 to the liquid ejection head 3, and ink that has passed through the interior of the liquid ejection head 3 is collected to the supply system of the apparatus 1000. In this way, ink is allowed to circulate through the paths in the apparatus 1000 and the paths in the liquid ejection head 3.

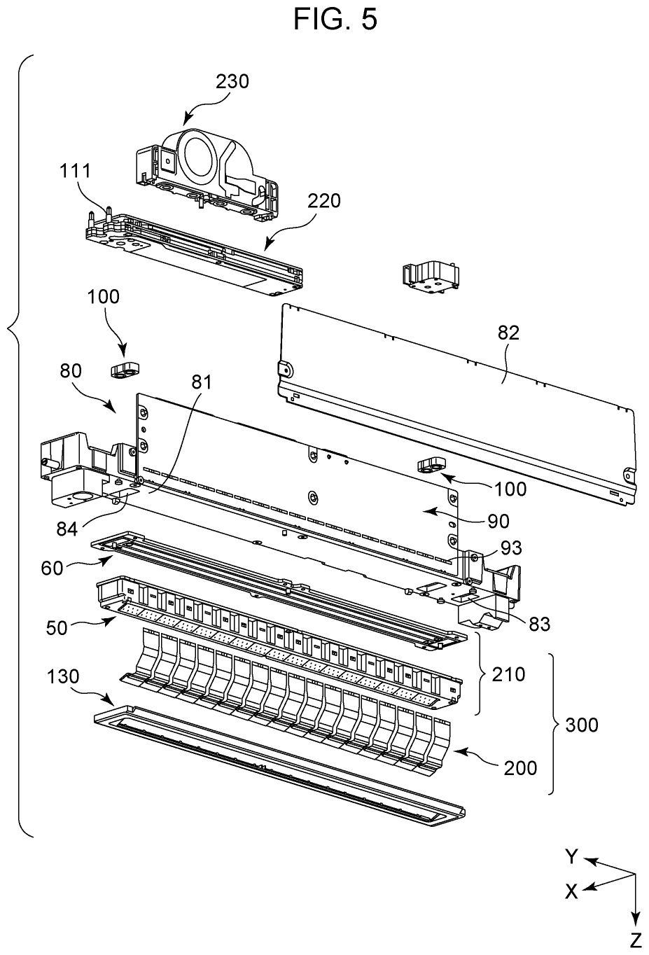

FIG. 5 is an exploded perspective view of the liquid ejection head 3, illustrating components or units constituting the liquid ejection head 3. The liquid ejection unit 300, the liquid supply unit 220, and the electric wiring board 90 are mounted to a housing 80. The liquid supply unit 220 is provided with the liquid connection part 111. A filter 221 (FIG. 3) is disposed inside the liquid supply unit 220 to remove foreign matter present in the ink being supplied. The filter 221 communicates with each opening of the liquid connection part 111. The liquid that has passed through the filter 221 is supplied to the negative-pressure control unit 230 disposed on the liquid supply unit 220. The negative pressure control unit 230 includes units having pressure regulating valves and uses the action of a valve, a spring member, or the like in each of the units to drastically attenuate a pressure loss change in the supply system (the upstream supply system of the liquid ejection head 1) of the apparatus 1000, which may occur with variation in the flow rate of the liquid.

As a result, the variation of negative pressure downstream of the negative-pressure control unit 230 (near the liquid ejection unit 300) can be stabilized to be within a given fixed range. Two pressure-regulating valves are built in the negative-pressure control unit 230. The pressure-regulating valves are each set to a different control pressure. Of the pressure-regulating valves, the one with the higher pressure setting and the one with the lower pressure setting respectively communicate with the common supply channel 211 and the common collection channel 212, which are located within the liquid ejection unit 300, via the liquid supply unit 220.

The housing 80 includes a liquid-ejection-unit support part 81, and an electric-wiring-board support part 82 to support the liquid ejection unit 300 and the electric wiring board 90, respectively, and also ensure rigidity of the liquid ejection head 3. The electric-wiring-board support part 82, which serves to support the electric wiring board 90, is secured by screwing onto the liquid-ejection-unit support part 81. The liquid-ejection-unit support part 81 has openings 83 and 84 into which joint rubber 100 is to be inserted. The liquid supplied from the liquid supply unit 220 is introduced via the joint rubber 100 to a second channel member 60, which constitutes the liquid ejection unit 300.

Reference is now made to the configuration of a channel member 210 included in the liquid ejection unit 300. As illustrated in FIG. 5, in the channel member 210, a first channel member 50 and the second channel member 60 are laminated on each other. Multiple ejection modules 200 are bonded with adhesive (not illustrated) to a bonding face of the first channel member 50. The channel member 210 is a channel member for distributing, to the ejection modules 200, the liquid supplied from the liquid supply unit 220, and returning, to the liquid supply unit 220, the liquid exiting the ejection modules 200. The channel member 210 is secured by screwing onto the liquid-ejection-unit support part 81. This reduces warping or deformation of the channel member 210.

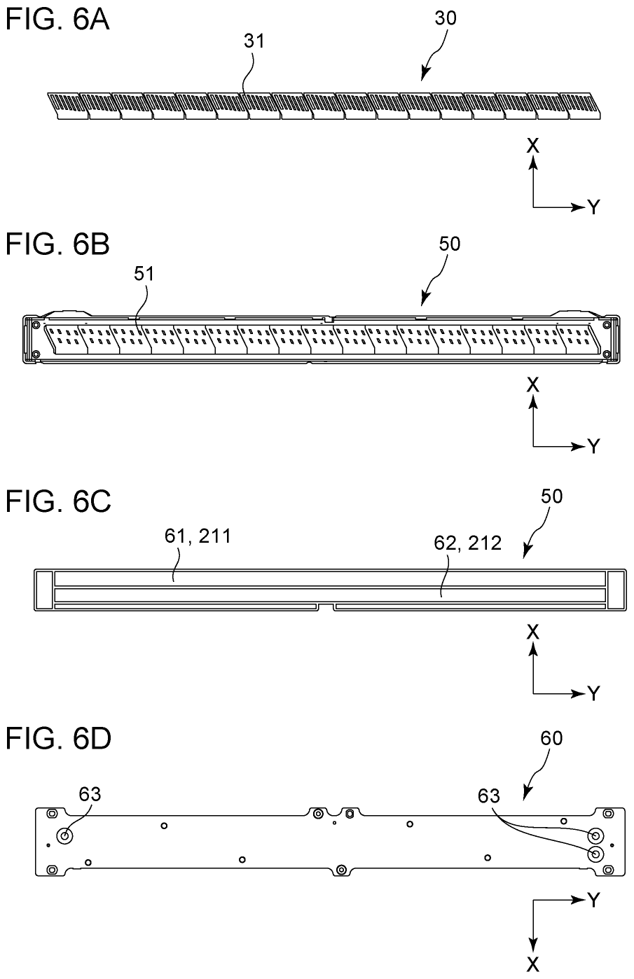

FIGS. 6A to 6D illustrate the configuration of the channel member 210 in detail. FIG. 6A illustrates support members 30, which are disposed on a face of the first channel member 50 to which the ejection modules 200 are to be mounted. FIG. 6B illustrates a face of the first channel member 50 that is in contact with the support members 30. FIG. 6C is a cross-section of the first channel member 50 taken along a plane perpendicular to the Z-direction and near the center in the Z-direction. FIG. 6D illustrates a face of the second channel member 60 that is in contact with the liquid-ejection-unit support part 81. FIGS. 6A to 6C are views seen from the ejection modules 200, and FIG. 6D is a view seen from the liquid-ejection-unit support part 81.

Multiple support members 30 are disposed on a face of the first channel member 50 opposite from the second channel member 60. The support members 30 are arranged in the Y-direction. A single element substrate 10 is disposed on each support member 30. Adjusting the number of the ejection modules 200 to be arranged makes it possible to form the liquid ejection head 3 in various sizes.

As illustrated in FIG. 6A, each support member 30 has communication ports 31 on its face that is in contact with the element substrate 10. The communication ports 31 are in fluid connection with the element substrate 10, and are to serve as the individual supply channels 213a and the individual collection channels 213b described above with reference to FIG. 3. As illustrated in FIG. 6B, the communication ports 31 are in fluid communication with the common supply channel 211 or the common collection channel 212 via communication ports 51 of the first channel member 50.

As illustrated in FIG. 6C, in the middle layer near the center in the Z-direction of the first channel member 50, common channels 61 and 62, which are to serve as the common supply channel 211 and the common collection channel 212 described above with reference to FIG. 3, extend in the Y-direction. As illustrated in FIG. 6D, a common communication port 63 is disposed at both ends or one end of the common channels 61 and 62.

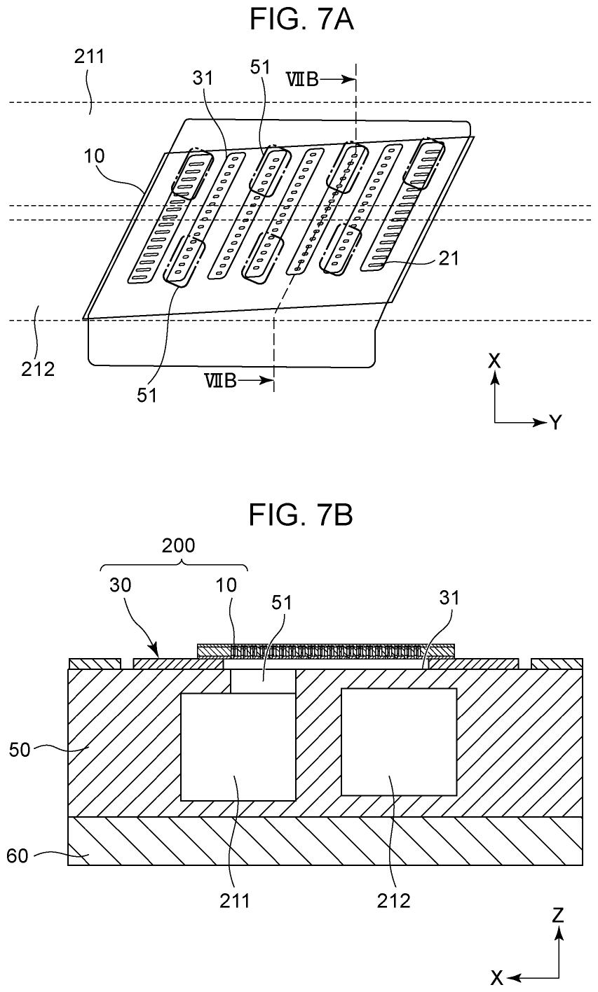

FIGS. 7A and 7B are a see-through view and a cross-sectional view, respectively, of a channel structure defined inside the liquid ejection unit 300. FIG. 7A is an enlarged see-through view of the channel member 210 as seen in the Z-direction, and FIG. 7B is a cross-sectional view taken along the line VIIB-VIIB of FIG. 7A.

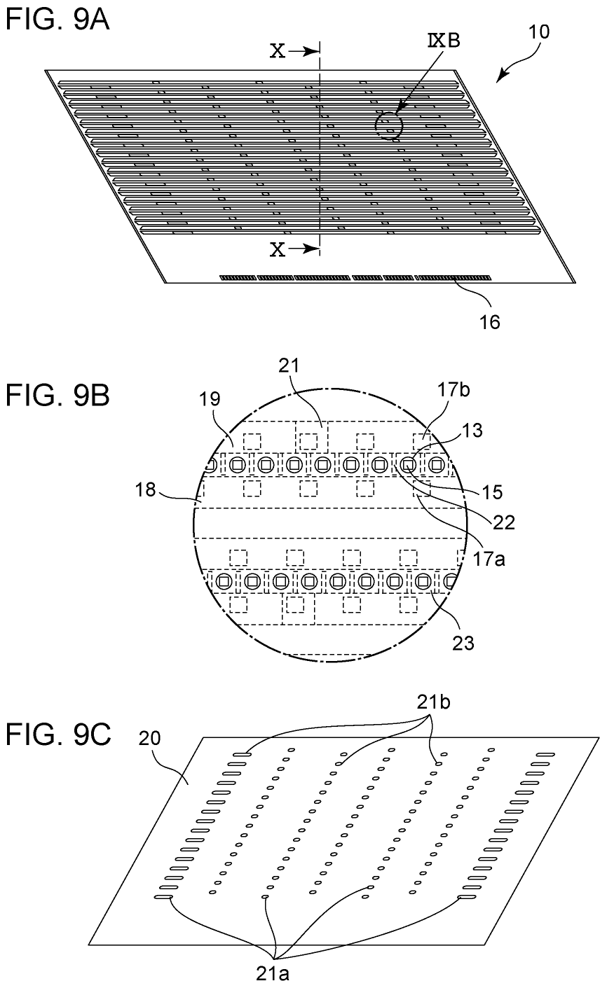

The element substrate 10 of the ejection module 200 is placed above the communication ports 51 of the first channel member 50 with the support member 30 interposed therebetween. Although FIG. 7B depicts only the communication port 51 corresponding to the common supply channel 211, when viewed in another cross-section, the common collection channel 212 and the communication port 51 communicate with each other as illustrated in FIGS. 6B and 6C. The support member 30 and the element substrate 10 that are included in each ejection module 200 each have defined therein a channel for supplying the ink from the first channel member 50 to heating resistance elements 15 (see FIG. 9B) provided to the element substrate 10. Further, the support member 30 and the element substrate 10 each have defined therein a channel for collecting (recirculating), to the first channel member 50, part or the whole of the liquid supplied to the heating resistance elements 15.

As described above, the common supply channel 211 is connected to the negative-pressure controller 230H, which is at a relatively high pressure, and the common collection channel 212 is connected to the negative-pressure controller 230L, which is at a relatively low pressure. An ink supply path is formed, which passes through the common communication port 63 (see FIG. 6D), the common supply channel 211, and the communication port 31 to supply ink to a channel defined within the element substrate 10. Likewise, an ink collection path is formed, which passes from a channel within the element substrate 10 through the communication port 31, the communication port 51, the common collection channel 212, and the common communication port 63 (see FIG. 6D). While ink is circulated in this way, an ejection operation is performed in the element substrate 10 in accordance with ejection data. At this time, a portion of the ink supplied through the ink supply path is not consumed by the ejection operation. The unconsumed portion of the ink is collected by the ink collection path.

### Configuration of Ejection Module

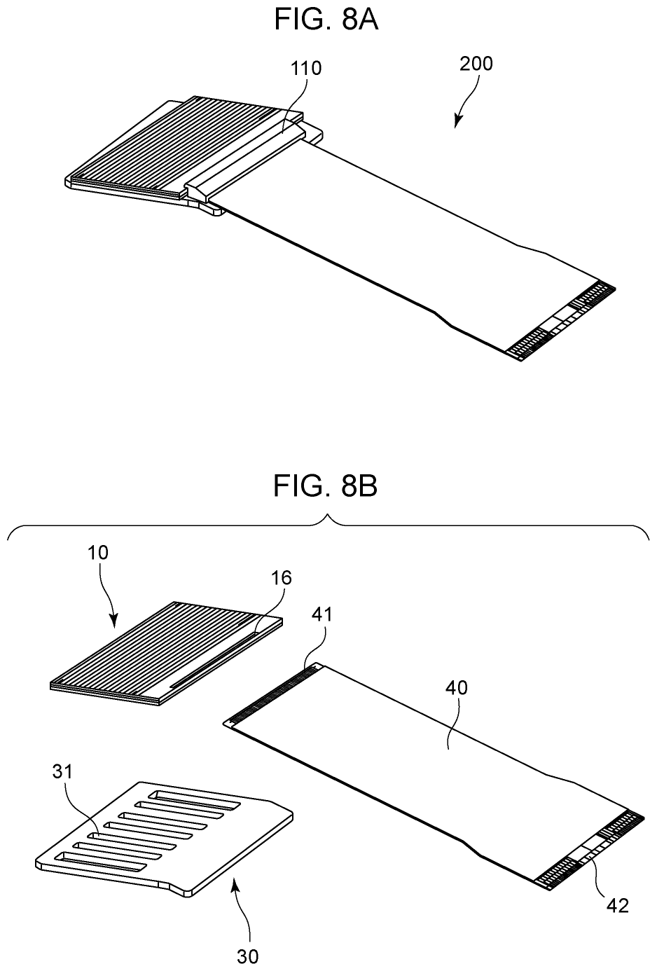

FIG. 8A is a perspective view of one ejection module 200, and FIG. 8B is an exploded view of the ejection module 200. The ejection module 200 is manufactured by a method as described below. First, the element substrate 10 and the flexible wiring board 40 are bonded onto the support member 30 in which the communication ports 31 are provided in advance. Subsequently, electrode pads 16 on the element substrate 10, and a terminal 41 on the flexible wiring board 40 are electrically connected by wire bonding, and then the wire-bonding portion (electric connection part) is covered and sealed with a sealant 110. As the flexible wiring board 40, for example, a copper foil is bonded with adhesive onto a polyimide tape, and then subjected to patterning to form wiring for electrical connection with the electrode pads 16 on the element substrate 10. A terminal 42, which is located at a side of the flexible wiring board 40 opposite from the element substrate 10, is electrically connected to a connection terminal 93 (see FIG. 5) of the electric wiring board 90. The support member 30 serves as a support that supports the element substrate 10, and also serves as a channel member that provides fluid communication between the element substrate 10 and the channel member 210. For this reason, the support member 30 that can be suitably used may be one that has a high flatness, and that is capable of bonding to the element substrate with sufficient reliability. The support member 30 may be made of, for example, alumina or a resin material. Details on sealing of the electric connection part will be given later.

### Configuration of Element Substrate

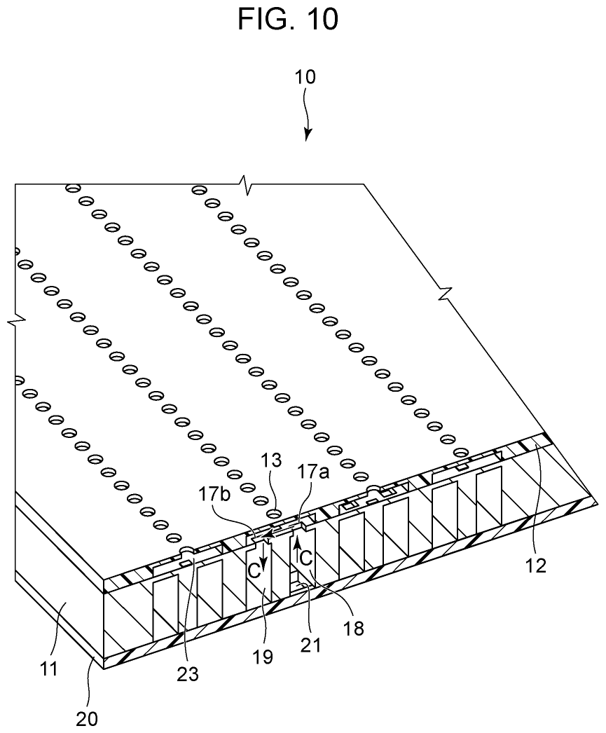

The configuration of the element substrate 10 according to the first embodiment is described below. FIG. 9A is a plan view of a face of the element substrate 10 where ejection ports 13 are provided. FIG. 9B is an enlarged view of a portion IXB in FIG. 9A. FIG. 9C is a plan view of a back face opposite from the face illustrated in FIG. 9A. FIG. 10 is a cross-sectional perspective view of the element substrate 10 taken along the line X-X of FIG. 9A. The direction in which an ejection port array including an arrangement of multiple ejection ports 13 extends will be referred to as “ejection port array direction” hereinafter.

As illustrated in FIG. 9B, heating resistance elements 15 are disposed at positions corresponding to associated ejection ports 13. Each heating resistance element 15 serves as a heating element (pressure generating element) for causing a liquid to generate a bubble by use of thermal energy generated by the heating resistance element 15. Pressure chambers 23 are divided from each other by partition walls 22 defined by a first layer 121 (described later) of a channel forming member 12. Each pressure chamber 23 includes the heating resistance element 15 disposed therein. The heating resistance element 15 is electrically connected to the electrode pad 16 by electric wiring (not illustrated) provided to the element substrate 10. The heating resistance element 15 boils the liquid by generating heat based on a pulse signal that is input from a control circuit of the liquid ejection apparatus 1000 via the electric wiring board 90 (see FIG. 5) and the flexible wiring board 40 (see FIGS. 8A and 8B). The force of the bubble generated by boiling causes the liquid to be ejected from the ejection port 13. As illustrated in FIG. 9B, along each ejection port array, a liquid supply passage 18 extends on one side, and a liquid collection passage 19 extends on the other side. The liquid supply passage 18 and the liquid collection passage 19 are channels extending in the direction of each ejection port array disposed on the element substrate 10. The liquid supply passage 18 and the liquid collection passage 19 respectively communicate with the corresponding ejection port 13 via a supply port 17a and a collection port 17b. FIG. 9A to FIG. 9C illustrate an example in which the element substrate 10 has 16 ejection port arrays.

As illustrated in FIG. 9C and FIG. 10, a cover plate 20 in sheet form is laminated on the back face of the element substrate 10 opposite from the face provided with the ejection ports 13. As illustrated in FIG. 9C, the cover plate 20 is provided with multiple openings 21 (described later) that communicate with the liquid supply passage 18 and the liquid collection passage 19. According to the first embodiment, four supply openings 21a are provided for each single liquid supply passage 18, and three collection openings 21b are provided for each single liquid collection passage 19. However, the above-mentioned numbers of these openings are not intended to be limiting. As illustrated in FIG. 9B, each of the openings 21 in the cover plate 20 communicates with the corresponding communication port 51 illustrated in FIG. 7A. The cover plate 20 may be made of a material with sufficient corrosion resistance with respect to the liquid. Further, high precision is desired for the shape and position of the openings 21 to allow supply of ink to the pressure chamber. For this reason, the cover plate 20 may be made of a material such as a photosensitive resin material or silicon, and the openings 21 may be formed by photolithography. As described above, the cover plate 20 serves to change channel pitch by use of the openings 21. From the viewpoint of pressure loss, strength, and workability, the cover plate 20 to be used may be a film-shaped member with a thickness of about 30 to 600 μm (micrometers).

The flow of liquid within the element substrate 10 is now described. The element substrate 10 is a laminate of a substrate 11, which is made of silicon, and the channel forming member (ejection port forming member) 12 made of photosensitive resin. According to the first embodiment, the channel forming member 12 has the first layer 121 (middle layer) for defining the pressure chambers 23, and a second layer 122 (lower layer) including the ejection ports 13. The first layer 121 and the second layer 122 are laminated in this order on a face (first face 11a) of the substrate 11, and patterned through exposure at the respective optimum photosensitive wavelengths of these layers, followed by development to thereby form the channel forming member 12. As the manufacturing method for the channel forming member 12 other than the above-mentioned method of laminating the first and second layers, any suitable manufacturing method can be used, such as forming the pressure chambers and the ejection ports by use of, for example, a mold material.

The cover plate 20 is bonded to the back face of the substrate 11. The cover plate 20 serves as a lid that defines part of the respective walls of the liquid supply passage 18 and the liquid collection passage 19, which are provided in the substrate 11 of the element substrate 10. In the element substrate 10, one face of the substrate 11 is provided with the heating resistance elements 15 (see FIG. 9B), and the back face of the substrate 11 opposite from the one face is provided with grooves defining the liquid supply passage 18 and the liquid collection passage 19, which extend along each ejection port array. The liquid supply passage 18 and the liquid collection passage 19, which are defined by the substrate 11 and the cover plate 20, are respectively connected to the common supply channel 211 and the common collection channel 212, which are provided within the channel member 210 (see FIGS. 7A and 7B). A differential pressure exists between the liquid supply passage 18 and the liquid collection passage 19. Due to the differential pressure, a circulatory flow C is formed in which the liquid within the liquid supply passage 18 provided in the substrate 11 flows to the liquid collection passage 19 via the supply port 17a, the pressure chamber 23, and the collection port 17b (the flow indicated by the arrow “C” in FIG. 10). For the ejection port 13 and the pressure chamber 23 where an ejection operation is not being performed, the above-mentioned flow makes it possible to collect, to the liquid collection passage 19, thickened ink resulting from evaporation through the ejection port 13, bubbles, foreign matter, and other substances. The above-mentioned flow also makes it possible to reduce, for example, thickening of ink at locations such as the ejection port 13 or the pressure chamber 23, or an increase in the concentration of the colorant of ink. As illustrated in FIGS. 7A and 7B, the liquid collected to the liquid collection passage 19 is collected, by way of the opening 21 in the cover plate 20 and the communication port 31 of the support member 30, to the supply path of the liquid ejection apparatus 1000 by flowing through the following parts in the order stated below: the communication port 31 of the support member 30; the communication port 51 of the first channel member 50; and the common collection channel 212.

That is, the liquid supplied from the body of the liquid ejection apparatus to the liquid ejection head 3 is supplied and collected by flowing in the order described below. First, the liquid flows from the liquid connection part 111 of the liquid supply unit 220 into the liquid ejection head 3. The liquid is then supplied by passing through the following parts in the order stated below: the joint rubber 100: the common communication port 63 provided in the second channel member; and the common channel 61 and the communication port 51 that are provided in the first channel member. Subsequently, the liquid is supplied to the pressure chamber 23 by passing through the following parts in the order stated below: the communication port 31 provided in the support member 30; the opening 21 provided in the cover plate 20; and the liquid supply passage 18 and the supply port 17a that are provided in the substrate 11. A portion of the liquid supplied to the pressure chamber 23 is not ejected from the ejection port 13. Such a liquid that has not been ejected flows through the following parts in the order stated below: the collection port 17b and the liquid collection passage 19 that are provided in the substrate 11; the opening 21 provided in the cover plate 20; and the communication port 31 provided in the support member 30. Subsequently, the liquid flows through the following parts in the order stated below: the communication port 51 and the common channel 62 that are provided in the first channel member; the common communication port 63 provided in the second channel member; and the joint rubber 100. The liquid then flows from the liquid connection part 111, which is provided to the liquid supply unit, to the outside of the liquid ejection head 3. According to the configuration of the circulation path illustrated in FIG. 3, the liquid entering from the liquid connection part 111 passes through the negative-pressure control unit 230 before being supplied to the joint rubber 100.

The liquid ejection head according to the first embodiment further includes a temperature control mechanism (not illustrated) provided to the element substrate 10. The element substrate 10 is sectioned into multiple areas for temperature control. A temperature sensor, and an individually controllable sub-heater are provided for each individual area. The controller 500 (see FIG. 2) performs temperature control by using the temperature sensor and the sub-heater, based on a temperature (target temperature) set for each individual area. That is, the controller 500 drives the sub-heater only for an area where the temperature detected by the temperature sensor is less than or equal to the target temperature. Setting a reasonably high target temperature for the element substrate 10 makes it possible to lower the viscosity of ink, and consequently to perform an ejection operation or circulation in a suitable manner. Through such temperature control, variations such as temperature variations within the element substrate 10, or temperature variations among multiple element substrates 10 are kept within a predetermined range. This makes it possible to reduce variations in the amount of ejection resulting from temperature variations, and reduce density unevenness in the recorded image. The target temperature of the element substrate 10 can be set to a temperature approximately equal to or higher than the equilibrium temperature of the element substrate 10 that is reached when all of the heating resistance elements 15 are driven at the highest assumed drive frequency. As the temperature sensor, a diode sensor, an aluminum sensor, or other sensors can be used. As a heating unit for heating the element substrate 10, it is possible to use the heating resistance element 15, which is a heating element. More specifically, the element substrate 10 may be heated by application, to the heating resistance element 15, of a voltage that is not so high as to cause bubble generation. For example, as a heating unit, the heating resistance element 15 may be used instead of the sub-heater, or the sub-heater and the heating resistance element 15 may be used in combination.

### Flow of Liquid Near Pressure Chamber

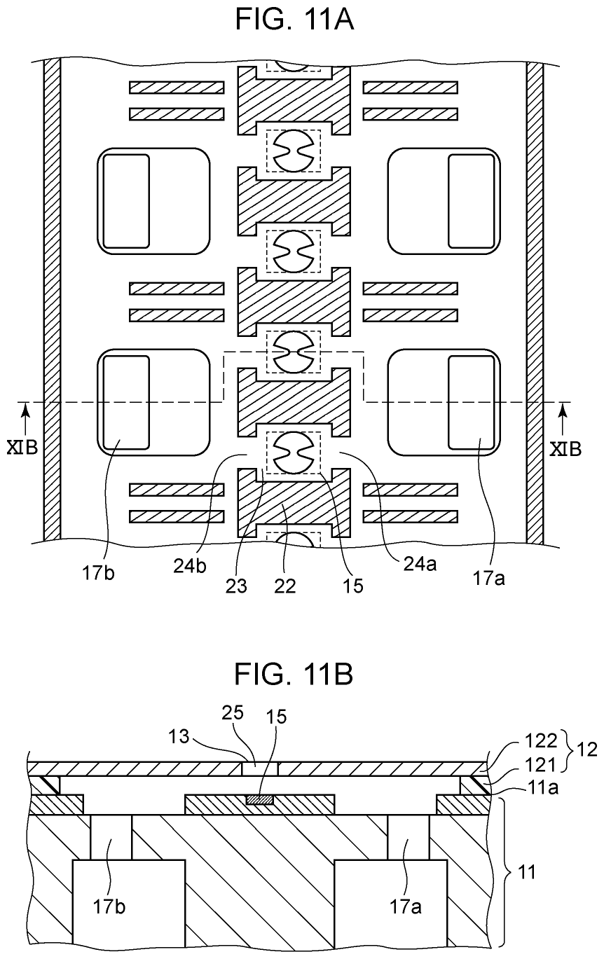

FIGS. 11A and 11B illustrate the interior of the liquid ejection head. FIG. 11A illustrates, in plan view (see-through view), heating resistance elements and channels. FIG. 11B is a cross-section taken along the line XIB-XIB of FIG. 11A. The following components are disposed between the substrate 11 and the channel forming member 12 of the element substrate 10: multiple pressure chambers 23 each including the ejection port 13; and an inlet passage 24a and an outlet passage 24b that communicate with each of the pressure chambers 23. Each pressure chamber 23 is partitioned off with the partition wall 22 of the channel forming member 12. In the substrate 11, the circulatory flow C (see FIG. 10) is formed as the liquid within the liquid supply passage 18 flows to the liquid collection passage 19 via the supply port 17a, the inlet passage 24a, the pressure chamber 23, the outlet passage 24b, and the collection port 17b. The speed of the circulatory flow C within the pressure chamber may be, for example, greater than or equal to 1.0 mm/s and less than or equal to 250 mm/s (millimeters per second). A speed within this range does not significantly affect, for example, the landing accuracy of droplets even when an ejection operation is performed while the liquid is flowing. As illustrated in FIG. 11B, the ejection port 13 is an opening that is defined in the channel forming member 12, and that is located at an end of a nozzle 25 having a tubular shape. The nozzle 25 provides communication between the ejection port 13 and the pressure chamber 23. The direction in which the liquid is ejected from the ejection port 13 (the vertical direction in FIG. 11B) is referred to as “ejection direction”, and the direction in which the liquid flows within the pressure chamber 23 (the horizontal direction in FIG. 11B) is referred to simply as “flow direction.”

Multiple supply ports 17a form a supply port array, and multiple collection ports 17b form a collection port array. An ejection port array including an arrangement of multiple ejection ports 13 is provided between the supply port array and the collection port array.

As previously mentioned, according to the first embodiment, a pressure difference is provided between the liquid supply passage 18 and the liquid collection passage 19. The pressure difference gives rise to the circulatory flow C, in which ink is introduced from the supply port 17a to the pressure chamber 23 through the inlet passage 24a and the ink flows from the outlet passage 24b to the collection port 17b.

The heating resistance element 15 is disposed at a bottom face of the pressure chamber 23 that faces the ejection port 13. At a position where the nozzle (nozzle) 25 faces the pressure chamber 23, the nozzle 25 extends through the channel forming member 12.

The outer end of the nozzle 25, that is, an end opposite from the heating resistance element 15, defines the ejection port 13 through which ink is ejected. The nozzle 25 or the ejection port 13 is positioned to face the heating resistance element 15. As used herein, the term “ejection port 13” means an opening located in an outer surface of the channel forming member 12 that faces the recording medium 2, and the term “nozzle 25” means a part that provides communication between the ejection port 13 and the pressure chamber 23, and that is a through-hole extending through the channel forming member 12.

As illustrated in FIGS. 11A and 11B, according to the first embodiment, the liquid ejection head does not include a filter in the form of, for example, a columnar structure, which is often disposed within a channel in the liquid ejection head to prevent foreign matter such as dust from entering the pressure chamber 23. This configuration makes it possible to reduce flow resistance within the channel, and improve ink refilling performance. This in turn may allow for, for example, increased ejection frequency. According to the present disclosure, foreign matter may be trapped by a channel (inlet passage 24a) within the channel forming member that has a relatively small height. This makes it possible to eliminate a filter.

### Shape of Ejection Port

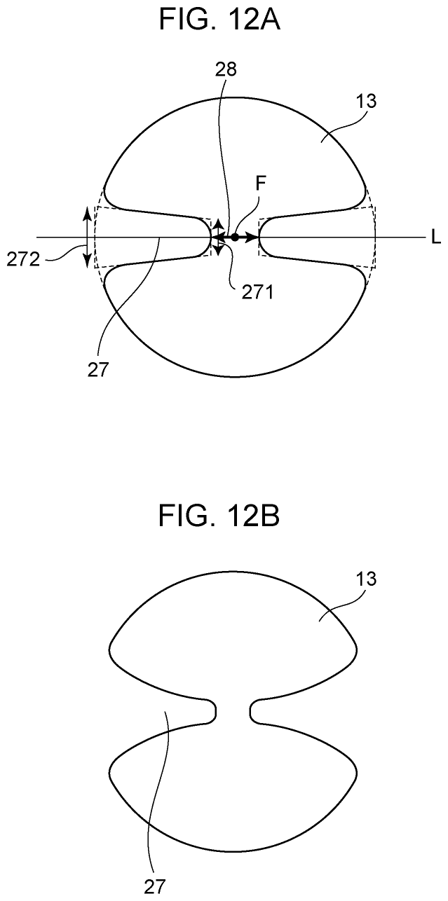

FIG. 12A illustrates, in plan view, the shape of the ejection port 13 according to the first embodiment. FIG. 12B illustrates, in plan view, another example of the shape of the ejection port 13. As illustrated in FIG. 12A, according to the first embodiment, two protrusions 27 are disposed on a straight line L passing through a center F of the ejection port 13. The protrusions 27 are identical in shape, and located at opposite sides with respect to the center F. The protrusions 27 protrude toward the center F. This may advantageously lead to a reduced tail length of the ejected droplet. This is explained below in more detail. The meniscus of ink formed between the protrusions 27 is likely to be maintained in comparison to the meniscus at other locations. Consequently, the droplet tail extending from the ejection port 13 can be cut off at an earlier timing. This makes it possible to reduce generation of mist made up of minute droplets that follow the primary droplet. FIGS. 1 to 11B may in some cases depict the ejection port 13 with the protrusions 27 omitted. A larger spacing 28 between the protrusions 27 tends to result in a longer tail of the ejected droplet and in the consequent formation of small satellite droplets. For this reason, the spacing 28 is desirably less than or equal to 7.0 μm, and more desirably less than or equal to 5.0 μm. A too small spacing, however, may in some cases make forming or shaping of the protrusions difficult, or cause the ejected droplet to split in two. For this reason, the spacing 28 may be greater than or equal to 2.0 μm. That is, the spacing 28 is desirably greater than or equal to 2.0 μm and less than or equal to 7.0 μm, and more desirably greater than or equal to 2.0 μm and less than or equal to 5.0 μm. In one example of the first embodiment, the spacing 28 is set at 3.0 μm.

If each protrusion 27 has a thick tip (near the center F), this may in some cases cause the ejected droplet to be broken up by the protrusion 27 into two droplets. For this reason, a width 271 at the tip portion of the protrusion 27 may be less than or equal to 4.0 μm. In one example of the first embodiment, the width 271 is 2.0 μm. If the protrusion has a rounded tip as in the case of the first embodiment illustrated in FIG. 12A, then as indicated by dotted lines in FIG. 12A, the width 271 of its tip portion can be regarded as the length of a line segment obtained by cutting a line that is located at the tip of the protrusion and that is orthogonal to the straight line L, by the intersection points of the line with two lines that are extensions of the two long sides of the protrusion. In addition, from the viewpoint of increasing the strength of the protrusion 27, a width 272 at the root portion of the protrusion 27 may be greater than the width 271 at the tip portion. In one example of the first embodiment, the width 272 is 4.0 μm. If the ejection port 13 has a curved shape at the root portion as in the case of the first embodiment illustrated in FIG. 12A, then as indicated by dotted lines in FIG. 12A, the width 272 at the root portion can be regarded as the length of a line segment connecting two intersection points between the following lines: the line of circumference of the ejection port 13 when the ejection port 13 has the shape of a circle; and two lines that are extensions of the two long sides of the protrusion. As described above, from the viewpoint of droplet formation, the protrusion 27 may have a shape that becomes narrower from the root portion toward the tip portion. The protrusion 27 may have an arcuate shape as illustrated in FIG. 12B.

The two protrusions 27 mentioned above may extend in a direction substantially parallel to the conveyance direction (X-direction) of the recording medium 2. Since the protrusions 27 have a very significant effect on droplet ejection, slight manufacturing variations between the shapes of the two protrusions cause the droplet to be displaced toward one of the protrusions during its flight. This results in landing position misalignment. Generally, landing position misalignment in the direction of ejection port arrangement (Y-direction) is more visually noticeable on the image than is landing position misalignment in the conveyance direction (X-direction) of the recording medium. Accordingly, orienting the protrusions substantially in parallel to the conveyance direction of the recording medium 2 makes it advantageously possible to reduce misalignment in the direction of ejection port arrangement, and consequently maintain satisfactory print quality. The protrusions 27 may extend in the direction of liquid flow near the pressure chamber. In other words, the straight line L on which the protrusions lie may have an angle of less than or equal to 45 degrees relative to the channel axis that connects the liquid supply passage 18 and the liquid collection passage 19 or connects the inlet passage 24a and the outlet passage 24b.

According to the first embodiment, two protrusions 27 extend toward the center F of the ejection port as described below. In this regard, the presence of only one such protrusion 27 can still provide satisfactory droplet formation. In this case, however, the landing position may become displaced significantly toward a location where no protrusion 27 is present, which potentially leads to decreased stability of the landing position. For this reason, two protrusions 27 may be provided so as to extend toward the center F of the ejection port. The present disclosure is also suitably applicable to liquid ejection heads whose ejection ports have no protrusion 27.

Further, with a view to achieving satisfactory image quality with stable ejection quality, the dot size of the droplets landing on the recording medium 2 may be relatively small to allow for high definition. Accordingly, for the liquid ejection head according to the first embodiment, the ejection volume is set to a relatively small value of 2.0 ng.

### Positional Relationship Between Element Substrates

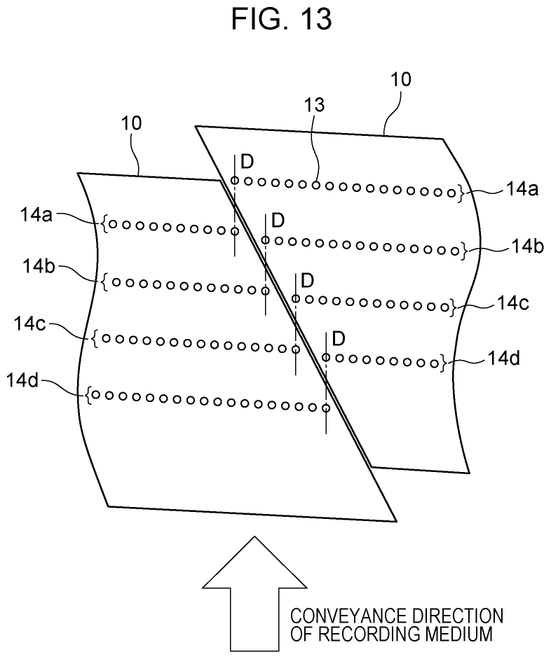

FIG. 13 is a partial enlarged plan view of a part where the respective element substrates of two mutually adjacent ejection modules are adjacent to each other. As illustrated in FIGS. 9A and 9C, the outer shape of the element substrate 10 according to the first embodiment is substantially a parallelogram. As illustrated in FIG. 13, each element substrate 10 is provided with ejection port arrays (14a to 14d) each including an arrangement of the ejection ports 13. Each ejection port array is inclined at a fixed angle relative to the direction of the recording medium 2. Due to this configuration, at the location where the element substrates 10 are adjacent to each other, at least one ejection port 13 of an ejection port array and at least one ejection port 13 of another ejection port array overlap each other in the conveyance direction of the recording medium 2. In FIG. 13, two ejection ports lying on a line D are in an overlapping relationship with each other. Due to this arrangement, even if the element substrate 10 is displaced slightly from a predetermined location, controlling the driving of the mutually overlapping ejection ports allows black streaks or white lines in the recorded image to be made less noticeable. That is, even when multiple element substrates 10 are disposed in an inline arrangement rather than a staggered arrangement in order to reduce an increase in the length of the liquid ejection head 3 in the conveyance direction of the recording medium 2, employing the configuration illustrated in FIG. 13 makes it possible to address black streaks or white lines in the overlap portion of the element substrates 10. According to the first embodiment, the major face of the element substrate 10 has the shape of a parallelogram. However, this is not intended to limit the present disclosure. The configuration according to the present disclosure can be also applied to element substrates whose major face has another shape, such as a rectangle or a trapezoid.

### Configuration for Preventing Flow of Sealant

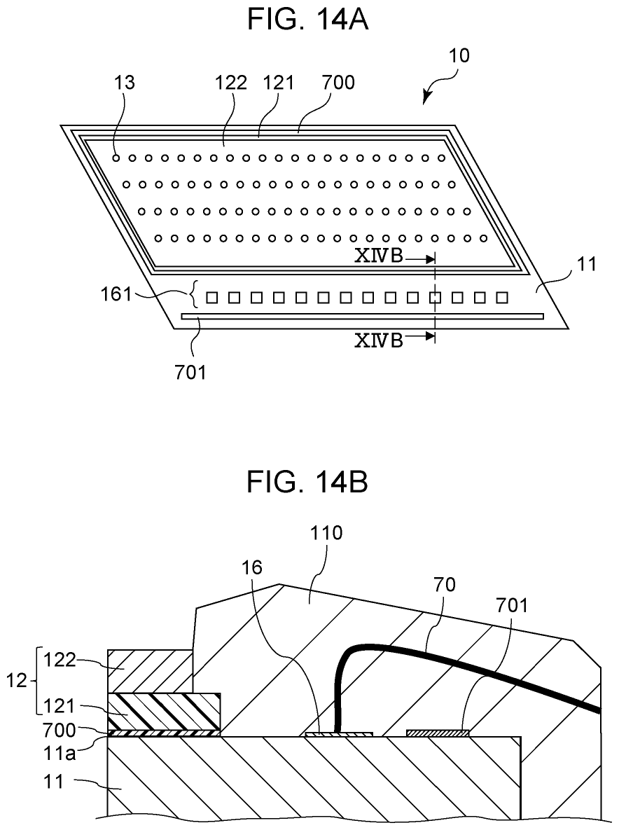

A problem to be addressed by the present disclosure is described below with detailed reference made to how an electric connection part 70 is sealed in the ejection module 200. As previously mentioned, the electric connection part (wire bonding part) between the element substrate and the electric wiring board is covered with the sealant 110. Flowing of the sealant during its application results in incomplete coverage of the wire. To address this, some liquid ejection heads according to the related art include a structure 701 provided by using an adhesion layer that serves to improve adhesion between the substrate 11 and the channel forming member 12 (or the first layer 121). The structure 701 serves as a wall for preventing the sealant 110 from flowing to the outside of the substrate 11. FIG. 14A is a plan view of the element substrate 10 according to the related art. In FIG. 14A, in plan view of the element substate, the structure 701 made of the same material as that of an adhesion layer 700 is disposed between an electrode pad array 161, which is an array of the electrode pads 16 arranged along one side of the substrate 11, and the one side of the substrate 11. A potential issue with this configuration, however, is that since the adhesion layer 700 generally has a small thickness of 1 to 2 μm, the sealant 110 may flow over the structure 701 to the outside of the substrate. To address this, according to the present disclosure, the above-mentioned wall for preventing the sealant 110 from flowing to the outside of the substrate 11 is formed by using the channel forming member 12.

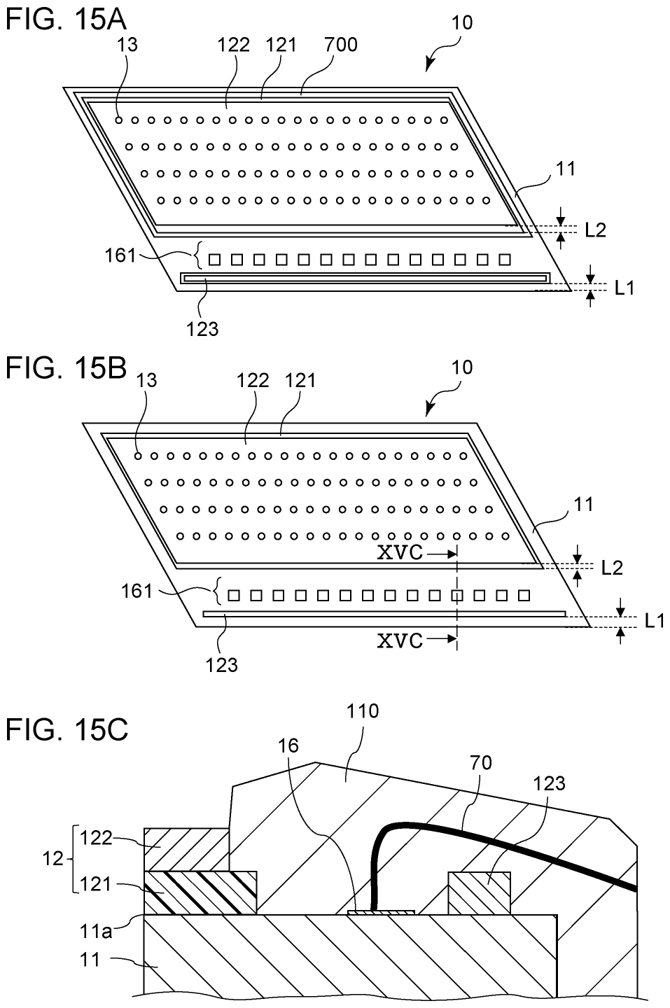

FIGS. 15A to 15C illustrate the element substrate 10 according to the first embodiment. According to the first embodiment, a structure 123 is provided between the electrode pad array 161 and one side of the element substrate 10. The structure 123 is made of the same material as that of the channel forming member 12, and serves as a wall to prevent the sealant from flowing from a location where the sealant has been applied. As described above, the structure 123, which serves as a wall for preventing the sealant from flowing, is formed by using the same layer as the channel forming member 12. This makes it possible to further prevent flowing of the sealant 110, without increasing the number of manufacturing steps and by using a wall that has a greater height than the adhesion layer 700.

As previously mentioned, the adhesion layer 700 is a layer made of resin provided to improve the adhesion between the channel forming member 12 and the substrate 11. The adhesion layer may contain resin, for example, may contain at least one of polyimide resin and polyetheramide resin. When the adhesion layer 700 made of resin is to be provided, the adhesion layer 700 is applied in its liquid form onto the substrate 11. This places limitations on the manufacturing process, such as the need to apply the adhesion layer before features such as channels or pressure chambers are formed through patterning of the channel forming member 12. If the adhesion between the channel forming member 12 and the substrate 11 is good, then there is no need to provide the adhesion layer 700, in which case the first layer 121 may be disposed in contact with the first face 11a of the substrate 11. This configuration has the advantage of placing fewer limitations on the manufacturing process and reducing the number of manufacturing steps in comparison to the case where the adhesion layer is provided. To improve the adhesion of the first layer 121 to the substrate, for example, the first layer 121 may be made of a resin containing polyethylene glycol. FIG. 15B is a plan view of the element substrate 10 according to the first embodiment with no adhesion layer 700 provided. FIG. 15C is a cross-section of the ejection module 200 corresponding to the position indicated by the line XVC-XVC in FIG. 15B. It is to be noted, however, that the support member 30 is not illustrated in FIG. 15C.

The structure 123 may have a height of greater than or equal to 3 μm and less than or equal to 25 μm in a direction perpendicular to the substrate 11. One reason for this is that an excessively small height of the structure 123 makes it more likely for the sealant 110 to flow as in the case of the configuration illustrated in FIGS. 14A and 14B in which the structure is provided by using the adhesion layer 700 alone. Another reason is that an excessively large height of the structure 123 makes it more difficult to apply the sealant 110 to fill in areas near the electric connection part 70, or makes it more difficult to form the electric connection part 70. In FIG. 15C, the structure 123 is formed by the first layer 121 of the channel forming member alone. This configuration may make it easier for the structure 123 to have a height that makes it easier to achieve both the prevention of flowing of the sealant 110 and the ease of forming of the electric connection part 70.

A distance L1, which is the distance between the structure 123 and the end of a side of the substrate 11 along which the electrode pad array 161 is disposed, may be greater than or equal to 2 μm and less than or equal to 200 μm. In particular, in some cases, a large distance between the end of the substrate 11 and the structure 123 tends to result in a large distance between the end of the substrate 11 and the electrode pad array 161, which in turn tends to make it difficult to form the electric connection part 70.

As illustrated in FIG. 15C, in a direction parallel to the first face 11a and orthogonal to the direction in which the electrode pad array 161 extends, the distance between the first layer 121 and the electrode pad array 161 is less than the distance between the second layer 122 and the electrode pad array 161. That is, when viewed in a cross section orthogonal to the electrode pad array 161, the first layer 121 and the second layer 122 are in a stepped configuration. This configuration increases the area of contact of the sealant 110 with the first layer 121, and consequently allows for increased adhesion of the sealant 110 to the element substrate 10. In particular, if the second layer 122 has a water-repellent layer at a face where the ejection ports 13 are present, the adhesion between the second layer 122 and the sealant 110 is poor. The above-mentioned stepped configuration of the first layer 121 and the second layer 122, which allows for increased area of contact between the sealant 110 and the first layer 121, is particularly advantageous for such a case. In a direction that is parallel to the first face 11a, and that is orthogonal to the direction in which the electrode pad array 161 extends, a distance L2, which is the distance between an end of the first layer 121 near the electrode pad array 161 and an end of the second layer 122 near the electrode pad array 161, can be, for example, 1 to 2000 μm.

The following description of embodiments focuses on differences from the first embodiment described above, and features similar to those described above are not described in further detail.

### Second Embodiment

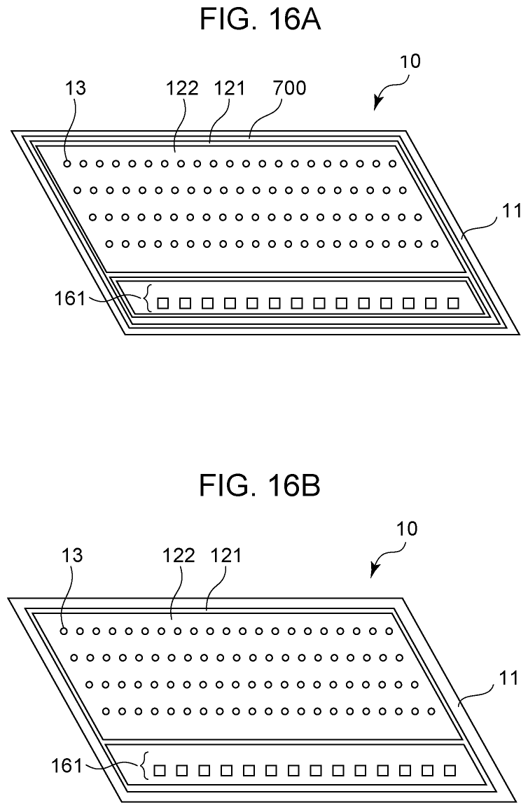

FIGS. 16A and 16B illustrate the element substrate 10 according to a second embodiment. FIG. 16A illustrates the element substrate 10 having no adhesion layer, and FIG. 16B illustrates the element substrate 10 having an adhesion layer. With the configuration according to the first embodiment illustrated in FIGS. 15A to 15C, the sealant may in some cases flow to the outside of the element substrate 10 in the direction of arrangement of the electrode pads 16. To address this, according to the second embodiment, as illustrated in FIGS. 16A and 16B, the structure 123 made of the same material as that of the first layer 121 is disposed both on opposite sides in the direction of the arrangement of the electrode pads 16, and between a side of the element substrate 10 and the electrode pads 16. That is, in plan view of the element substrate 10, the structure 123 is positioned to surround the electrode pad array.

### Third Embodiment

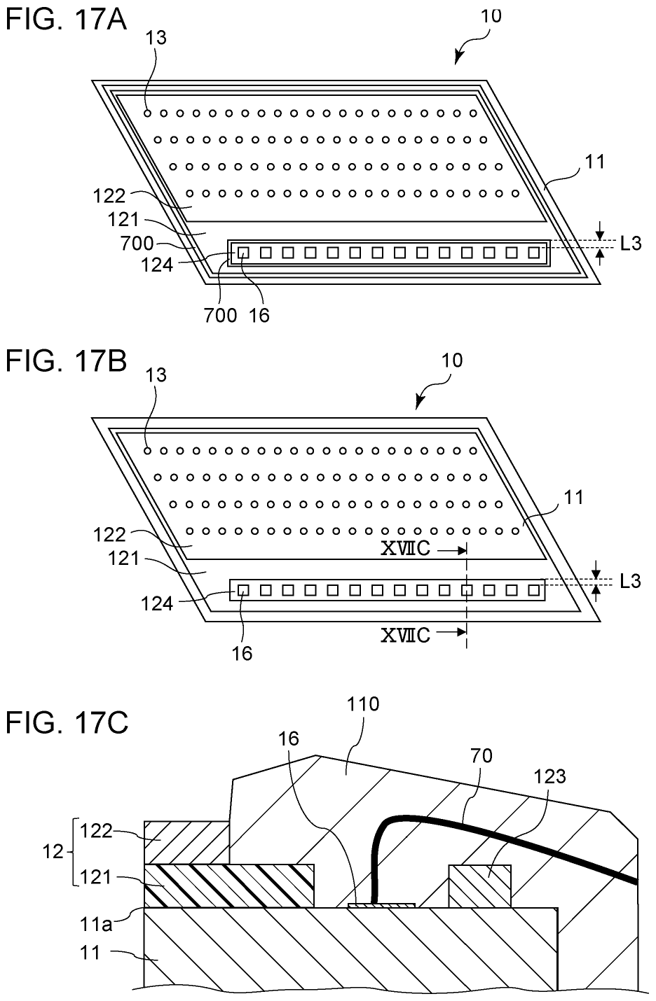

FIGS. 17A and 17B illustrate the element substrate 10 according to a third embodiment. FIG. 17A illustrates the element substrate 10 having no adhesion layer, and FIG. 17B illustrates the element substrate 10 having an adhesion layer. FIG. 17C is a cross-section of the ejection module 200 corresponding to the position indicated by the line XVIIC-XVIIC in FIG. 17B. According to the third embodiment, the first layer 121 is provided across substantially the entire first face 11a of the element substrate 10, and the first layer 121 is removed only around the electrode pad array 161. In other words, in plan view of the substrate 11, the electrode pad array 161 is located within an opening 124 provided in the first layer 121. As a result, an area of the substrate 11 that is covered by the first layer 121 increases relative to the first and second embodiments. This can lead to improved protection of the substrate 11. In other words, an area of the substrate 11 that is covered by the sealant 110 alone decreases relative to the first and second embodiments. This can lead to improved protection of the substrate 11. In this regard, in a direction parallel to the first face 11a, the first layer 121 and the electrode pad array 161 may have, on a side of the electrode pad array 161 near the region where the ejection ports are present, a distance L3 from each other that is greater than or equal to 2 μm and less than or equal to 200 μm.

In FIGS. 17A and 17B, the second layer 122 provided with the ejection ports 13 is disposed only in the region where the ejection ports 13 are present, and the opening 124 is provided only in the first layer 121. Alternatively, however, the channel forming member 12 may be disposed across substantially the entire first face 11a of the substrate 11, and the first layer 121 and the second layer 122 may be each provided with the opening 124.

### Fourth Embodiment

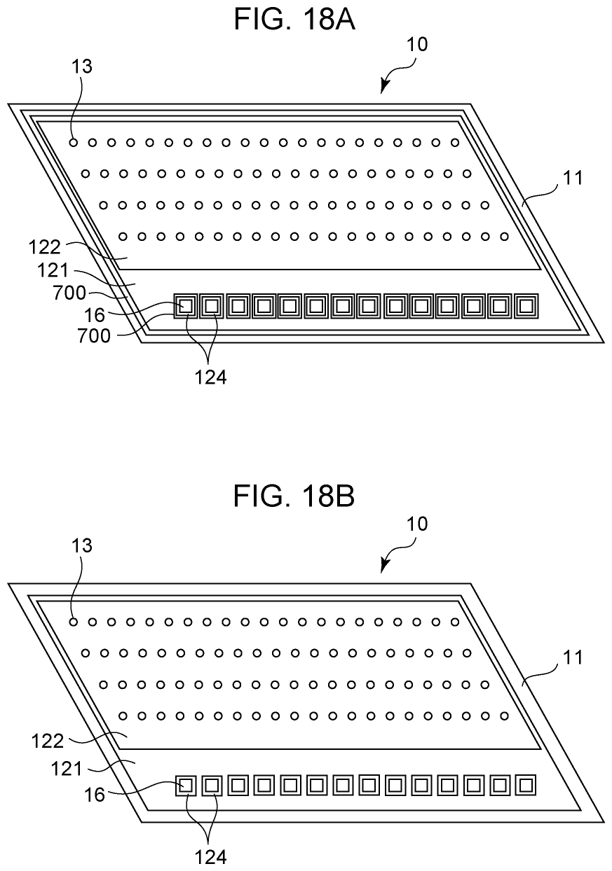

FIGS. 18A and 18B illustrate the element substrate 10 according to a fourth embodiment. FIG. 18A illustrates the element substrate 10 having no adhesion layer, and FIG. 18B illustrates the element substrate 10 having an adhesion layer. According to the fourth embodiment, the element substrate 10 is provided with multiple openings 124 where the first layer 121 is removed. The openings 124 correspond to individual associated electrode pads 16. As a result, an area of the substrate 11 that is covered by the first layer 121 increases relative to the third embodiment illustrated in FIGS. 17A to 17C. This can lead to improved protection of the substrate 11. In this case, for example, the first layer 121 and the electrode pad array 161 can have a distance from each other of greater than or equal to 2 μm and less than or equal to 20 μm in the direction parallel to the first face 11a.

As long as a single element substrate 10 has multiple openings 124, multiple electrode pads 16 may be disposed within each single opening 124. Such a configuration can as well provide improved protection of the substrate, in comparison to the configuration according to the third embodiment mentioned above in which all of the electrode pads 16 are disposed within a single opening provided in the first layer 121.

In FIGS. 18A and 18B, the second layer 122 provided with the ejection ports 13 is disposed only in the region where the ejection ports 13 are present, and multiple openings 124 are provided only in the first layer 121. Alternatively, however, the channel forming member 12 may be disposed across substantially the entire first face 11a of the substrate 11, and the first layer 121 and the second layer 122 may each be provided with the openings 124.

The present disclosure provides a liquid ejection head that prevents a sealant from flowing from a location where the sealant has been applied, and that provides improved electric reliability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-149010, filed on Sep. 14, 2023, which is hereby incorporated by reference herein in its entirety.

What is claimed is:

1. A liquid ejection head comprising:
an element substrate including
a substrate having a first face,
an element configured to eject a liquid,
a channel forming member including a pressure chamber and an ejection port, the ejection port being a port communicating with the pressure chamber and through which the liquid is ejected, and
a pad array including a plurality of pads electrically connected to the element, the plurality of pads being arranged along one side of the substrate,
the element, the channel forming member, and the pad array being disposed at the first face of the substrate;
an electric wiring board connected to each of the plurality of pads via an electric connection part; and
a sealant disposed on the first face of the substrate and surrounding the electric connection part,
wherein, in plan view of the element substrate, the channel forming member has an opening, and the pad array is located within the opening.

2. The liquid ejection head according to claim 1,
wherein the channel forming member includes:
a first layer disposed on a side of the first face and defining the pressure chamber; and
a second layer disposed on a side of the first layer opposite from the substrate, the second layer having the ejection port, and
wherein the opening is disposed in the first layer.

3. The liquid ejection head according to claim 2,
wherein, in a direction perpendicular to the substrate, the first layer has a height of greater than or equal to 3 μm and less than or equal to 25 μm (micrometers).

4. The liquid ejection head according to claim 2,
wherein, in a direction that is parallel to the first face, and that is orthogonal to a direction in which the pad array extends, on a side of the pad array near the ejection port, a distance between the first layer and the pad array is less than a distance between the second layer and the pad array.

5. The liquid ejection head according to claim 2,
wherein, in a direction that is parallel to the first face, and that is orthogonal to a direction in which the pad array extends, the first layer and the pad array have a distance from each other of greater than or equal to 2 μm and less than or equal to 200 μm (micrometers).

6. The liquid ejection head according to claim 1,
wherein the electric connection part is a wire.

7. The liquid ejection head according to claim 1,
wherein the channel forming member is made of resin.

8. The liquid ejection head according to claim 2,
wherein the first layer is disposed in contact with the first face of the substrate.

9. The liquid ejection head according to claim 2,
wherein the first layer includes polyethylene glycol.

10. A liquid ejection head comprising:
an element substrate including
a substrate having a first face,
an element configured to eject a liquid,
a channel forming member including a pressure chamber and an ejection port, the ejection port being a port communicating with the pressure chamber and through which the liquid is ejected, and
a pad array including a plurality of pads electrically connected to the element, the plurality of pads being arranged along one side of the substrate,
the element, the channel forming member, and the pad array being disposed at the first face of the substrate;
an electric wiring board connected to each of the plurality of pads via an electric connection part; and
a sealant disposed on the first face of the substrate and surrounding the electric connection part,
wherein when viewed in a direction perpendicular to the substrate, the liquid ejection head comprises a structure disposed between the one side and the pad array, the structure and the channel forming member being made of a same material.

11. The liquid ejection head according to claim 10,
wherein, in the direction perpendicular to the substrate, the structure has a height of greater than or equal to 3 μm and less than or equal to 25 μm (micrometers).

12. The liquid ejection head according to claim 10,
wherein the channel forming member includes:
a first layer disposed on a side of the first face and defining the pressure chamber; and
a second layer disposed on a side of the first layer opposite from the substrate, the second layer having the ejection port, and
wherein the structure and the first layer are made of the same material.

13. The liquid ejection head according to claim 10,
wherein, in plan view of the element substrate, the structure is positioned to surround each of the plurality of pads.

14. The liquid ejection head according to claim 10,
wherein, in plan view of the element substrate, the structure is positioned to surround the pad array.

15. The liquid ejection head according to claim 12,
wherein, in a direction that is parallel to the first face, and that is orthogonal to a direction in which the pad array extends, the first layer and the pad array have, on a side of the pad array near the ejection port, a distance from each other that is less than a distance between the second layer and the pad array.

16. The liquid ejection head according to claim 10,
wherein the channel forming member is made of resin.

17. The liquid ejection head according to claim 12,
wherein the first layer is disposed in contact with the first face of the substrate.

18. The liquid ejection head according to claim 11,
wherein the first layer includes polyethylene glycol.

19. A manufacturing method for a liquid ejection head,
the liquid ejection head comprising:
an element substrate including
a substrate having a first face,
an element configured to eject a liquid,
a channel forming member including a pressure chamber and an ejection port, the ejection port being a port communicating with the pressure chamber and through which the liquid is ejected, and
a pad array including a plurality of pads electrically connected to the element, the plurality of pads being arranged along one side of the substrate,
the element, the channel forming member, and the pad array being disposed at the first face of the substrate;
an electric wiring board connected to each of the plurality of pads via an electric connection part; and
a sealant disposed on the first face of the substrate and surrounding the electric connection part,
wherein, in plan view of the element substrate, the channel forming member has an opening, and the pad array is located within the opening,
the manufacturing method comprising:
forming, on the first face of the substrate, a layer that is to serve as the channel forming member; and
forming the channel forming member by patterning the layer and simultaneously forming the pressure chamber and the opening.

20. The manufacturing method according to claim 19,
wherein, in the liquid ejection head,
the channel forming member comprises:
a first layer disposed on a side of the first face and defining the pressure chamber; and
a second layer disposed on a side of the first layer opposite from the substrate, the second layer having the ejection port, and
the opening is disposed in the first layer,
the manufacturing method comprising:
forming, on the first face of the substrate, a layer that is to serve as the first layer; and
simultaneously forming the pressure chamber and the opening by patterning the layer that is to serve as the first layer.
